(19) United States
(12) Patent Application Publication
(10) Pub. No.: US 2007/0289200 A1
(43) Pub. Date: Dec. 20, 2007

(54) Trap for Animals

(76) Inventor: Per Danielsson, Ljungby (SE)

Correspondence Address: LADAS & PARRY, 26 WEST 61ST STREET, NEW YORK, NY, 10023, US

(21) Appl. No.: 11/578,228

(22) PCT Filed: Apr. 13, 2005
(86) PCT No.: PCT/SE05/00529

§ 371 Date: May 30, 2007

(30) Foreign Application Priority Data
Apr. 14, 2004 (SE) 0400959-3

(51) Int. Cl. A01M 23/30

(52) U.S. Cl. 43/82

(57) ABSTRACT

Trap for an animal comprising a table (31), at which a bait may be arranged. A spring-loaded shackle (50) with a mass (53) is intended to hit the animal at the release of a locking device for the shackle. Above the table, there is a pivotable cover (41) and an link member (20) operated by the cover. The link member is connected to the locking plate (18), which retains the shackle in its activated position. The shackle is biased by two springs (54, 55) integral with the shackle.

### AREA OF INVENTION

The present invention relates to a trap for smaller or middle-sized animals such as rats. More specifically, the invention relates to a trap having a simple mechanical construction, in which the risk of injury has been minimized during set up of the trap.

### BACKGROUND ART

A common type of such traps is a mousetrap. A mouse trap commonly used in Sweden today comprises a shackle, which in the active position is folded up and spring loaded in order to, at release of the spring, hit towards the mouse and break the spine thereof right above the head of the mouse. An area provided with bait is arranged at a suitable place in relation to the shackle and a release mechanism normally retains the spring, but release the spring when a mouse tries to catch the bait. Such a mousetrap is for example described in EP-1011326.

U.S. Pat. No. 5,953,853 discloses a more complicated mousetrap, which uses electronic devices for sensing when a mouse is present at the bait. Moreover, there is a box into which the dead mouse is transported and from which the mouse may be discarded into a trash container, essentially without the user needing to come close to or touch the mouse.

When it comes to larger animals, such as rats, stronger constructions are required, which may kill such animals. Then, the spring should be stronger dimensioned. Moreover, it is of greater importance that the trap is safe so that it cannot be actuated by mistake during set-up or use, for example when a cat or dog comes close to the trap.

### SUMMARY OF INVENTION

An object of the present invention is to provide a trap having a simple mechanical construction in which the risk of injury is minimized at the set-up of the trap.

Another object of the invention is to provide a trap, which is mechanically safe, so that a cat, dog or other large animal cannot by mistake release the trap and become hurt.

A trap, which fulfils the above objects, is defined in the appended patent claims.

In a first aspect, there is provided a trap for animal comprising a table, at which a bait may be arranged, and a shackle biased by a spring and having a mass intended to hit the animal at the release of a locking device for the shackle. The trap comprises a pivotable cover arranged above the table; an link member connected with the cover; whereby the link member retains the shackle in an activated position until the cover makes free the shackle via the link member. The locking device may comprise a pivotable locking plate, which at one end cooperates with the shackle and at the other end cooperates with said link member. The shackle may be biased by a spring made integrally with said shackle in the nature of two spiral springs. The shackle may be pivotable around a second shaft, whereby the springs are arranged at said shaft.

In an embodiment, the shackle may comprise a mass, which is attached to the shackle at a distance from said second shaft. The cover may be pivotable around a first shaft, whereby the cover cooperates with the link member via an eccentric mechanism. The eccentric mechanism may comprise a shoulder arranged on the cover, which cooperates with an opening in the link member. The cover may be pivotable about 90 degrees, whereby the eccentric mechanism in this position is free from cooperation with the link member.

In another embodiment, a casing is arranged around the trap. Moreover, the trap may comprise a safety member, which is automatically made fee when the casing as arranged around the trap.

Further objects, features and advantages of the invention will appear from the detailed description given below of several embodiments of the invention with reference to the appended drawings.

### BRIEF DESCRIPTION OF THE DRAWINGS

FIG. 1 is a perspective view of a rattrap according to a first embodiment of the invention, with a casing thereof partly cut for showing the inner details.

FIG. 2 is a perspective view of a rattrap according to FIG. 1 in set-up position.

FIG. 3 is a longitudinal sectional view through the rattrap of FIG. 1 without the casing and in set-up position.

FIG. 4 is a cross-sectional view and FIG. 5 is a side view of a link member used in the rattrap according to FIG. 1.

### DETAILED DESCRIPTION OF EMBODIMENTS OF THE INVENTION

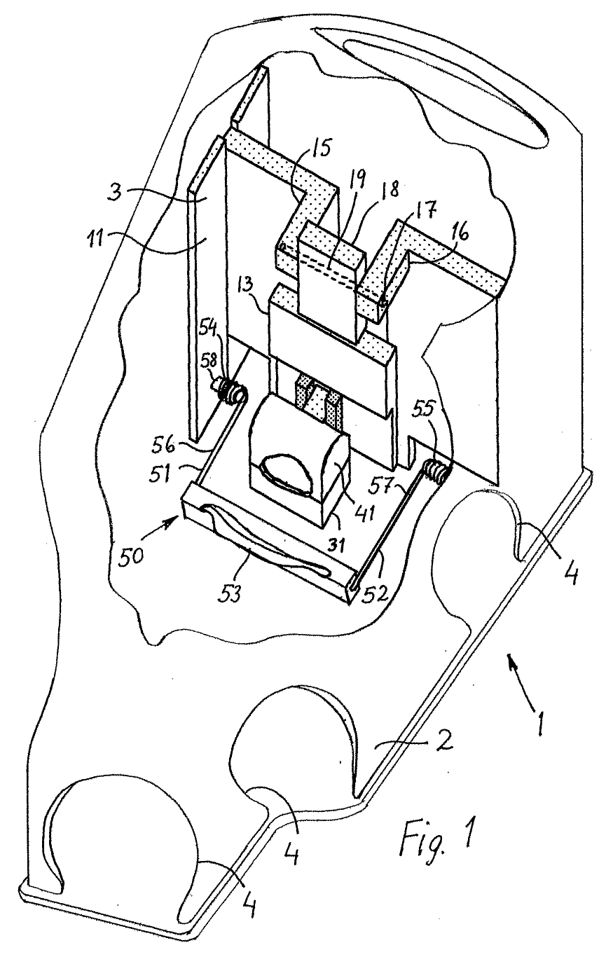

FIG. 1 is a partly cut perspective view of an embodiment of the invention.

Trap 1 comprises a casing 2 and a mechanism 3 of the trap. The mechanism 3 can be mounted in any suitable casing designed in view of the application for which the trap is intended to be used. In the embodiment shown in FIG. 1, the casing 2 has several openings 4. An animal can enter the trap through any of the openings 4. The casing can also be provided with a handle 5.

The casing 2 can also form a shelter during transport and application and is removed when the trap is set-up. Then, the mechanism 3 can be freestanding.

The casing can be attached to the mechanism via a pivotal connection, such as a shaft, or by means of a snap connection, so that the casing is completely separable from the mechanism.

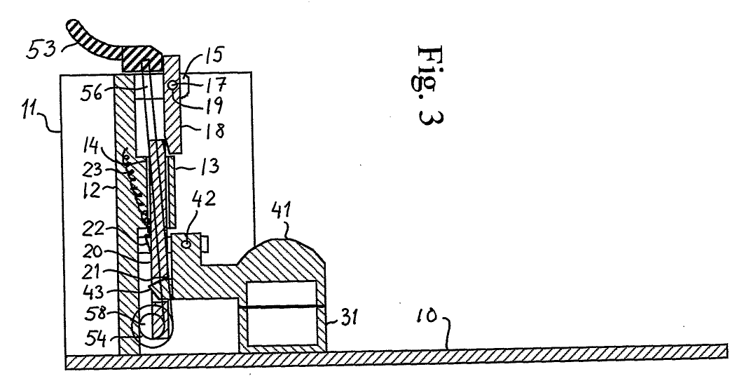

The mechanism comprises a floor 10 having mounted thereon two vertical gables 11, one of which is visible in FIG. 1. Between the gables, there is a stand 12. About at the middle of the stand 12, there is a shoulder 13, having a vertical, rectangular opening 14 (see FIG. 3). At the upper part of the stand, there are two lugs 15, 16 each having a through hole 17.

Between the lugs 15, 16, there is arranged a locking plate 18, which is pivotable around a shaft 19 passing through the hole 17 in said lugs 15, 16. The locking plate is eccentrically arranged so that the shaft 16 is positioned above the middle of the locking plate 18. In this way, the locking plate will be urged towards the vertical position shown in FIG. 1.

An link member 20 having a rectangular cross-section is arranged vertically moveable in the opening 14 of the shoulder 13 of the stand. The link member extends from the lower edge of the locking plate 18 and almost down to the floor 10, as shown in FIG. 3.

The link member is provided with an opening 21. The opening is essentially rectangular. As shown in FIG. 3, the upper edge of the opening is somewhat rounded, as is explained in further detail below.

At the floor, between the gables 11, there is a table 31 intended to enclose a bait (not shown), which may be a piece of cheese or other suitable bait.

Above the table, there is a cover 41, which normally prevents access to the bait at the table 31. The cover is normally pivotably arranged around a shaft 42. Moreover, the cover comprises a shoulder 43, which is intended to co-operate with the opening 21 of the link member 20, as is described below. The cover 41 can be pivoted from the horizontal position shown in FIG. 3 and essentially 90 degrees upward, wherein the table 31 will be accessible for application of the bait.

In this specification, the expressions horizontal and vertical are used and it is realized that such expressions relate to the situation when the trap is present on a horizontal support. However, the trap may be present on a sloping support or even hang vertically whereby the defined directions are modified accordingly.

The trap comprises a strong shackle 50, which is comprised of two spiral springs 51, 52 as shown in more detail in FIG. 1. Each spiral spring has a spring portion 54, 55 and shackle arm 56, 57 extending there from and bent 90 degrees at the end thereof. The bent portion cooperates with a mass 53 extending horizontally. By using two springs, a relatively large force is obtained so that the mass can hit and kill small and middle-sized animals, such as rats. Thus, the shackle 50 is pivotable around a shaft 58 at the lower part of the trap. Alternatively, the springs can be made in a single piece as a double spring, whereupon the mass 53 is attached at a portion connecting the shackle arms 56 and 57.

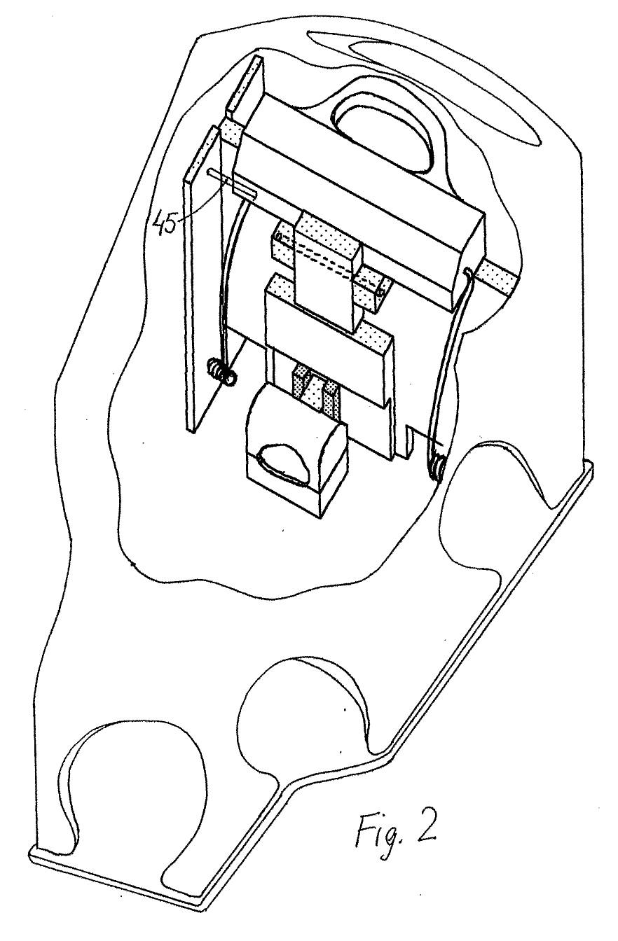

The shackle is shown in its released position in FIG. 1. At set-up, the shackle can be pivoted to the position shown in FIG. 2 and cooperates with the locking plate 18 by passing beyond the locking plate 18 during the set-up procedure. The locking plate 18 can be pivoted aside to let the shackle pass. Thereafter, the locking plate retains the shackle in the tensed position. This activated position is also shown in FIG. 3.

The vertical position of the link member 20 is determined by a nose or shoulder 43 arranged at said cover 41. The shoulder 43 extends into the opening 21 in the link member 20. The opening 21 is shaped so that the shoulder 43 passes in the opening with a small free space. As appears from FIG. 3, the rotation axis 42 of the cover is positioned above the shoulder 43. Thus, when the cover is pivoted upward from the horizontal position shown in FIG. 3, the shoulder 43 will be pivoted downward in an arc some millimeters and then out of the opening 21 of the link member 20. During the pivotal movement downward, the shoulder 43 pulls the link member 20 downward against the action of possible frictional forces, which prevent such movement. When the shoulder 43 passes out of the opening, the link member is in its lowest position shortly above the bottom of the floor 10. Due to this arrangement of the shoulder and the opening and the cover and its rotation axis, the cover will form an eccentric mechanism for the link member.

When the cover 41 is lifted a few millimeters, the shoulder will as described above force the link member downward a distance of a part of or a few millimeters, which is sufficient for the link member to leave free the locking plate 18. Then, the spring forces acting on the shackle will pivot the shackle and the mass to the right in FIG. 3 and down toward an animal, which is present immediately in front of the table and the cover 41. When hitting the animal, the shackle and the mass will break the spine of the animal immediately below the head and kill the animal.

From FIG. 3 it appears that the lower edge of the locking plate facing the link member is chamfered. By such chamfers, the surfaces are adapted so that a suitable force is required for moving the link member downward. If the chamfer is large, with a large angle, the frictional force will be small, and, oppositely, if the chamfer is less large with almost now angle, the frictional force will be large so that the rat will have it difficult to lift the cover.

The link member may be provided with a shoulder 22, which prevents that the link member moves too far upward. The floor limits the downward movement. Thus, the link member moves only a few millimeters between its two positions.

As also appears from FIG. 3, the shoulder 43 at the cover 41 is somewhat rounded at its upper surface, to that the shoulder easily passes into the opening 21 at the closing of the cover.

A spring may be arranged at the link member and bias it upward in order to assure that the link member does not release the locking plate unintentionally. Such a spring 23 is schematically shown in FIG. 3.

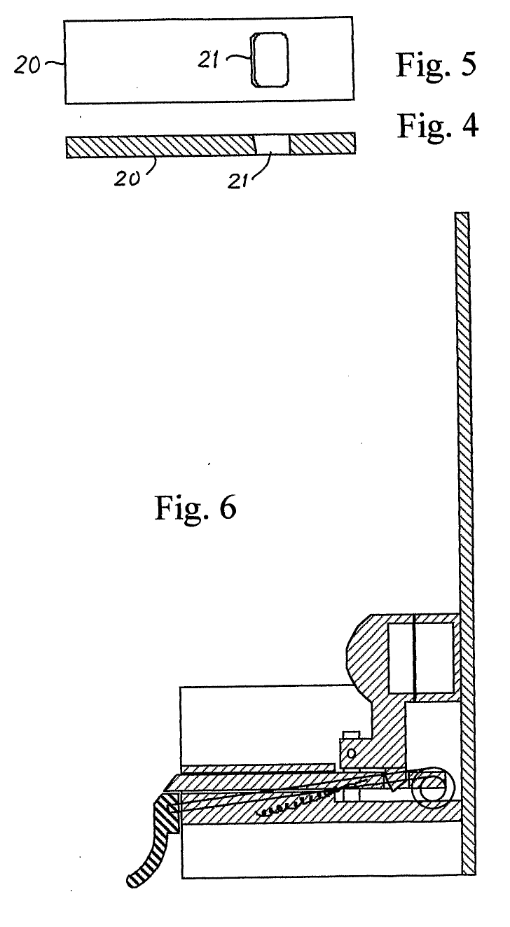

As appears from FIG. 4, the opening 21 of the link member 20 is positioned at the lower part of the link member. As appears from FIG. 5, the opening is essentially rectangular with rounded corners.

From FIG. 1 it appears that the spring portions 54, 55 are turned outward and have their anchoring positions in the gables. However, the spring portions may as well be turned inward, toward each other.

In an alternative embodiment shown in FIG. 6, the link member is extended upward and acts directly as a locking mechanism for the shackle be extending into the path of the shackle without the use of a locking plate. When the shackle is set-up, the link member must be positioned in its lower position so that the shackle can freely pass. When the cover is then lowered to the position shown in FIG. 1, the link member will lock the shackle and prevent the trap from activation until a trap animal has lifted the cover. Alternatively and as shown in FIG. 6, the link member may be provided with an inclined upper surface, which allows the shackle to pass during a set-up movement. Then, the link member snaps up to the locking position.

The shackle should be so broad and high so that it can embrace an animal to be killed. Thus, the shackle may be about 110 mm high and about 100 mm broad.

The stand can be made of light metal, such as aluminum, or alternatively, the entire trap is made of a plastic material, except the spring.

Because the trap is relatively strong, it may be suitable to provide it with a safety element, which prevents the trap from being activated unintentionally. When the trap is activated during set-up and placed at the right position, the safety element is removed and the trap is ready for operation. Such a safety element can be a lever arm 45, which cooperates with the shackle arms 56, 57 as shown in FIG. 2. The lever arm 45 prevents the shackle from being released by engaging the shackle arms of the spring. When the casing is applied at the mechanism, the casing may comprise a member that influences on the lever arm and moves it aside. For example, the lever arm may be arranged in a hole in the gable 11.

Herein above, embodiments of the invention have been described in order to elucidate the invention and so that a skilled person should be able to perform the invention. However, the invention is not limited to the features described or the constructions but is limited only by the patent claims below.

1. A trap for animal comprising a table (31), at which a bait may be arranged, and a shackle (50) biased by a spring and having a mass (53) intended to hit the animal at the release of a locking device for the shackle, characterized by
a pivotable cover (41) arranged above the table;
an link member (20) connected with the cover;
whereby the link member retains the shackle (50) in an activated position until the cover makes free the shackle via the link member.

2. The trap according to claim 1, characterized in that the locking device comprises a pivotable locking plate (18) which at one end cooperates with the shackle and at the other end cooperates with said link member.

3. The trap according to claim 1, characterized in that the shackle is biased by a spring (54, 55) made integrally with said shackle in the nature of two spiral springs.

4. The trap according to claim 3, characterized in that the shackle is pivotable around a second shaft (58) and in that the springs are arranged at said shaft.

5. The trap according to claim 4, characterized in that the shackle comprises a mass (53), which is attached to the shackle at a distance from said second shaft.

6. The trap according to claim 1, characterized in that the cover (41) is pivotable around a first shaft (42) and in that the cover cooperates with the link member (20) via an eccentric mechanism.

7. The trap according to claim 6, characterized in that the eccentric mechanism comprises a shoulder (43) arranged on the cover, which cooperates with an opening (21) in the link member.

8. The trap according to claim 6, characterized in that the cover (41) is pivotable about 90 degrees and in that the eccentric mechanism in this position is free from cooperation with the link member.

9. The trap according to claim 1, characterized in that a casing is arranged around the trap.

10. The trap according to claim 9, characterized in that the trap comprises a safety member (45), which is automatically made fee when the casing as arranged around the trap.
